(19) United States
(12) Patent Application Publication
(10) Pub. No.: US 2025/0236556 A1
(43) Pub. Date: Jul. 24, 2025

(54) ULTRA-HIGH PERFORMANCE CONCRETE

(71) Applicant: THE TEXAS A&M UNIVERSITY SYSTEM, College Station, TX (US)

(72) Inventor: Nancy Ahmed Soliman, College Station, TX (US)

(21) Appl. No.: 19/033,076

(22) Filed: Jan. 21, 2025

Related U.S. Application Data
(60) Provisional application No. 63/622,929, filed on Jan. 19, 2024.

(51) Int. Cl. C04B 18/12; C04B 18/14; C04B 20/02; C04B 28/16

(52) U.S. Cl. CPC C04B 18/12; C04B 18/146; C04B 20/023; C04B 28/16

(57) ABSTRACT

Disclosed herein are ultra-high-performance concrete compositions. The compositions have improved fresh properties relative to conventional UHPC compositions, and incorporate waste materials from mining operations, thereby reducing some of the environmental impacts caused by mining.

### CROSS-REFERENCE TO RELATED APPLICATION

This application claims the benefit of U.S. Provisional Application 63/622,929, filed Jan. 19, 2024, the contents of which are hereby incorporated in its entirety.

### BACKGROUND

Ultra-high-performance concrete (UHPC) provides ultra-high strength, high ductility, and excellent durability relative to conventional concrete. It typically consists of cement (<100 μm), silica fume (0.1-0.2 μm), quart powder (<100 μm), quartz sand (150-630 μm), water, superplasticizer, and/or fiber. It can be used in place of conventional high-performance concrete without passive reinforcement and can lead to longer structure spans with reduced size and weight, often less than 70% compared to normal or high-performance concrete. It also possesses superior durability leading to longer service life and reduced maintenance costs.

Despite these advantages, current UHPCs are not without their drawbacks. They have higher cement content (800-1,000 kg/m³) relative to other concretes as well as crystallized silica, thereby requiring higher energy inputs and natural resources to produce. The preparation of 1000 kg of UHPC can release about 864 kg CO₂, contributing to greenhouse gas emissions and global warming. Moreover, crystallized silica is considered carcinogenic.

Tailings are a byproduct of mining. They are the materials left over after the target mineral has been separated from the gangue of an ore. Tailings typically include particulate matter with grain size on the order of sand or smaller. Large amounts of particulate matter present disposal problems, as containment systems must be devised to prevent the particulate matter from entering the environment. The mining of certain minerals can produce a large amount of tailings when compared to the extracted ore. For example, up to ten tons of tailings can be generated for each mined ton of base metals such as copper, nickel, zinc, and lithium. Rarer elements, such as platinum and gold, would generate over one million kg of tailings for each mined kg. One such example of tailings is magnesium iron silicate, an olivine-rich intrusive igneous rock found in mafic and ultramafic rocks.

The remains a need for improved UHPC compositions and methods of making the same. There remains a need for improved concrete compositions with increased structural properties and decreased production costs. There remains a need to valorize mine tailings to reduce or eliminate the need to store them as waste products.

### BRIEF DESCRIPTION OF THE FIGURES

FIG. 1A: Photomicrograph of quartz sand; FIG. 1B: Photomicrograph of Twin Sisters MIS400; FIG. 1C: Photomicrograph of Åheim MIS140; FIG. 1D: Photomicrograph of quartz powder.

FIG. 2A: X-ray diffraction pattern for quartz sand; FIG. 2B: X-ray diffraction pattern for Twin Sisters MIS400; FIG. 2C: X-ray diffraction pattern for Åheim MIS140; FIG. 2D: X-ray diffraction pattern for quartz powder.

FIG. 3: XRD of gypsum before and after calcination at 650° C.

FIG. 4: Particle-size distributions of granular materials used in the UHPC mix design used to replace QS with different PSD of MIS.

FIG. 5: Particle-size distributions of granular materials used in the UHPC mix design used to replace QP with MSP66.

FIG. 6: Particle-size distributions of granular materials used in the UHPC mix design used to study the effect of the synergetic effect of CMIS and FMIS in replacing QS and QP respectively.

FIG. 7: Effect of QS replacement by MIS400 (FIG. 7A) shear stress evolution with share rate and (FIG. 7B) plastic viscosity with shear rate.

FIG. 8: Effect of QP replacement by MSP66 (FIG. 8A) shear stress evolution with share rate and (FIG. 8B) plastic viscosity with shear rate.

FIG. 9: Effect of (FIG. 9A) MIS mean particle size on the compressive strength after 48H of HC and (FIG. 9B) MIS content in replacing QS on the compressive strength at the ages of 1, 7, 28, 56, and 91 days under NC and 48H of HC.

FIG. 10: Effect of MSP66 content in replacing QP on the compressive strength at the ages of 1, 7, 28, 56, and 91 days under NC and 48H of HC.

FIG. 11: Effect of the synergetic effect of CMIS and FMIS in replacing QS and QP respectively on the compressive strength at the ages of 1, 7, 28, 56, and 91 days under NC and 48H of HC.

FIG. 12: Effect of SSC composition on compressive strength development of UHPC after 1, 7, 28 and 91 days under NC.

FIG. 13: Effect of Fine MIS as a partial cement replacement on compressive strength of UHPC after 2 days of HC.

FIG. 14: Effect of MIS content in replacing QS on the split tensile strength at the ages of 28 and 91 days under NC and 48H of HC.

FIG. 15: Effect of MSP66 content in replacing QP on the split tensile strength at the ages of 28 and 91 days under NC and 48H of HC.

FIG. 16: Effect of the synergetic effect of CMIS and FMIS in replacing QS and QP respectively on the split tensile strength at the ages of 28 days under NC and 48H of HC.

FIG. 17: Hydration process of UHPC with various QS replacement levels: (FIG. 17A) evolution of normalized hydration heat flow including the initial setting time and (FIG. 17B) normalized cumulative hydration heat flow.

FIG. 18: Hydration process of UHPC with various QP replacement levels: (FIG. 18A) evolution of normalized hydration heat flow including the initial setting time and (FIG. 18B) normalized cumulative hydration heat flow.

FIG. 19: Hydration process of UHPC with various QS and QP replacement levels: (FIG. 19A) evolution of normalized hydration heat flow including the initial setting time and (FIG. 19B) normalized cumulative hydration heat flow.

FIG. 20: Evolution of normalized hydration heat flow of UHPC with SSC.

FIG. 21: Pore size distributions and porosity of UHPC utilizing MIS as a replacement of QS with different replacement ratios at 28 days NC.

FIG. 22: Pore size distributions and porosity of UHPC MSP666 at 28 days NC.

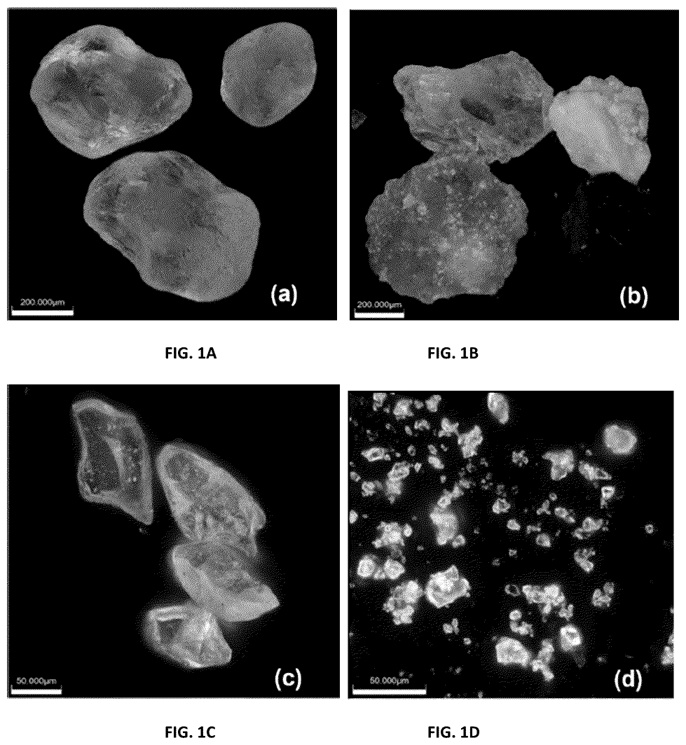

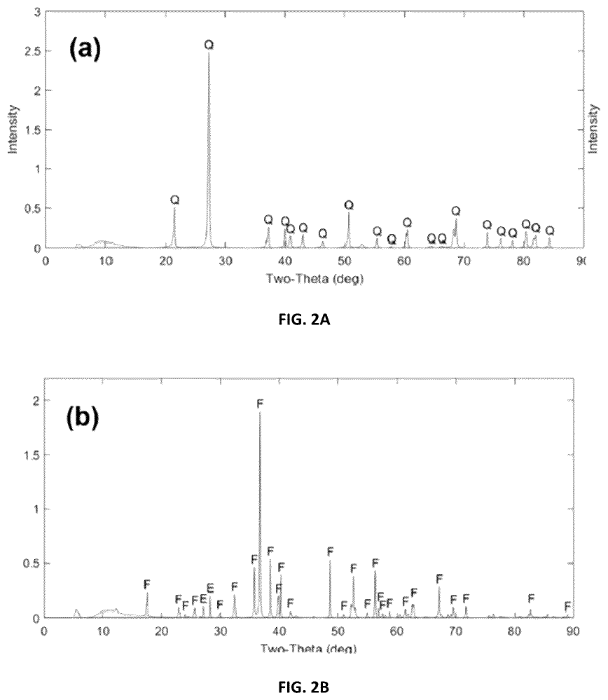

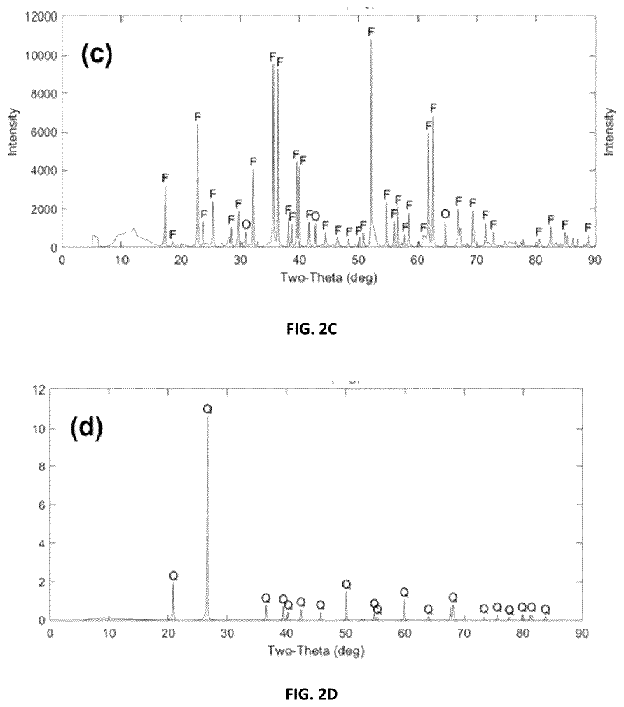

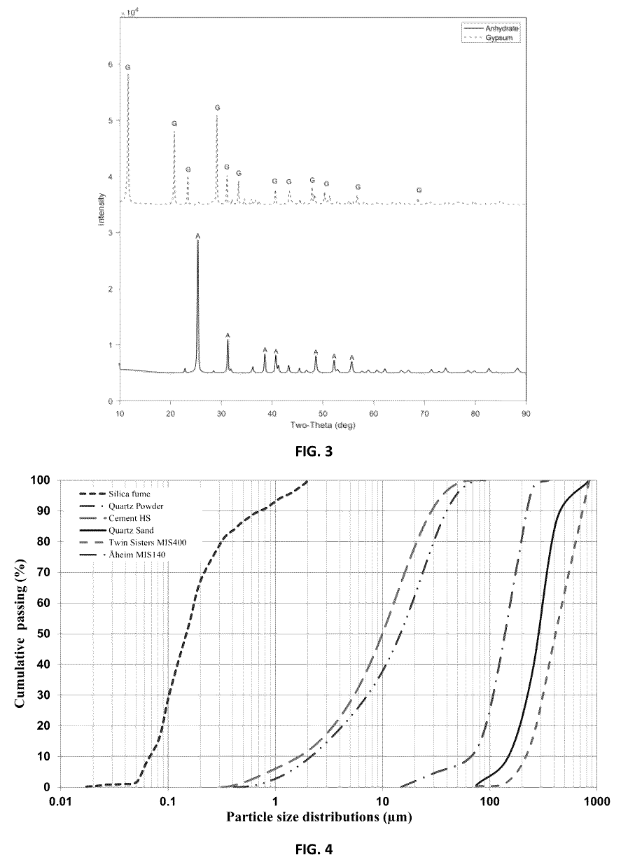

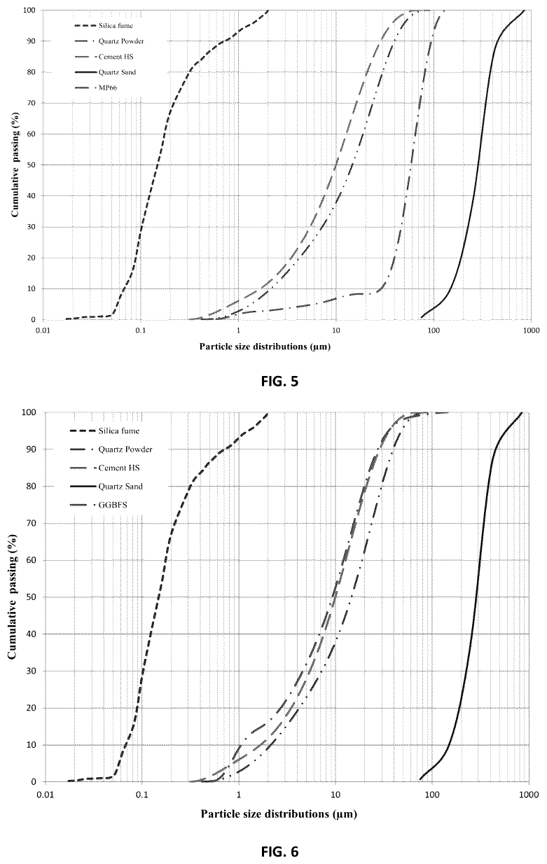

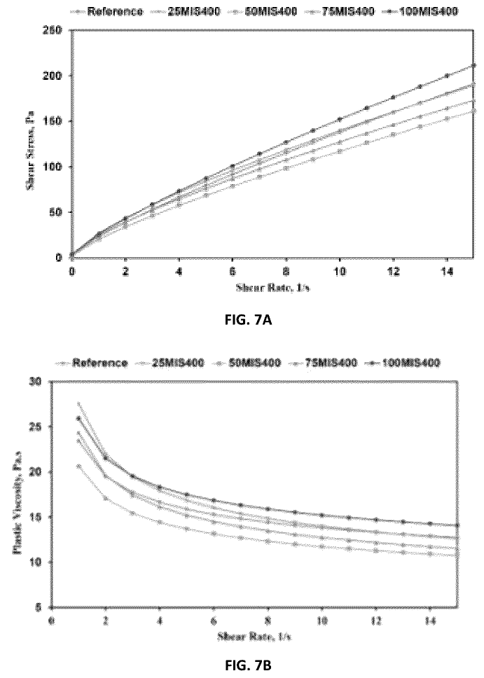

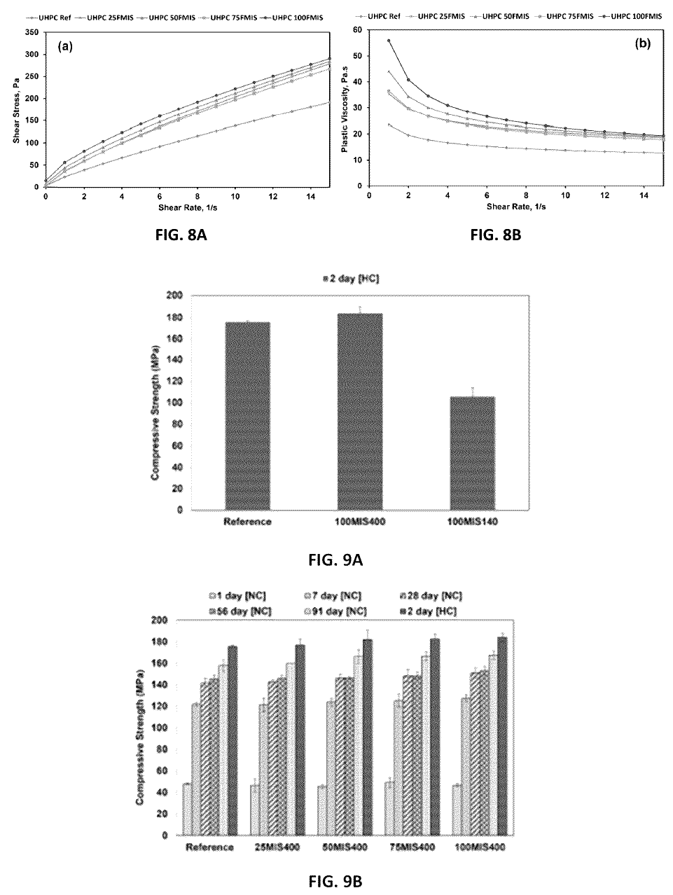

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Unless specified to the contrary, “wt. %” is relative to the referenced composition as a whole.

As used herein, “about” mean approximately. In some implementations “about” means within 10%, 5%, 4%, 3%, 2%, or 1% of the stated value.

As used herein, the term or phrase “cement” refers to a composition or substance with one or more constituents that is capable of binding materials together once set. In certain aspects, cement can include a number of dry constituents chosen based on the desired ratio or class of cement to be produced. Thus, cement refers to the dry, pre-set composition unless the context clearly dictates otherwise, for example, in a wet cement slurry or in a cured cement material. It is further understood that the general term “cement” comprises hydraulic cement, non-hydraulic cement, or a combination thereof.

The term “hydraulic cement” refers to any inorganic cement that hardens or sets due to hydration. As used herein, the term “hydraulically-active” refers to properties of a cement material that allow the material to set in a manner like hydraulic cement, either with or without additional activation. Hydraulic cements include Portland cements, aluminous cements, pozzolan cements, fly ash cements, and the like. Thus, for example, any of the oil well type cements of the class “A-H” as listed in the API Spec 10, (1st ed., 1982) are suitable hydraulic cements.

A “pozzolanic material” is a silicon- or aluminum-containing material that reacts with sodium hydroxide to form cement.

Disclosed herein are UHPC compositions. In some implementations the composition is a super-sulphated tailings (SST)-UHPC composition. In some implementations the composition includes a cement content between 0 and 1000 kg/m³. In some implementations the composition includes between 0 and 1000 kg/m³ of super sulphated cement (SSC). In some implementations the composition includes an aggregate including between 0 and 1400 kg/m³ of coarse magnesium iron silicate (CMIS). In some implementations the composition includes between 0 and 300 kg/m³ of reactive pozzolanic material (in an embodiment between 68 and 300 kg/m³). In some implementations the composition includes an aggregate including between 150 and 900 kg/m³ of carbonated, non-carbonated (or combination thereof) fine magnesium iron silicate (FMIS). In some implementations the composition includes an aggregate including between 0 and 600 kg/m³ of carbonated or non-carbonated (or combination thereof) ultrafine magnesium iron silicate (UFMIS). In some implementations the composition includes between 5 and 60 kg/m³ of superplasticizer. In some implementations the composition includes between 50 and 300 kg/m³ of fiber. In some implementations the composition includes between 5 and 150 kg/m³ of chemical activator. In some implementations the composition can further include between 130 and 275 kg/m³ of water. In some implementations the content of FMIS is of at least 5 wt. % of the SST-UHPC and the content of CMIS is of at least 15 wt. % of the composition. In an embodiment, a content of UFMIS is of at least 1 wt. % of the composition.

In some embodiments super sulphated cement (SSC) includes granulated slag mixed with, anhydrite calcium sulfate and a Portland cement.

In some implementations the fine magnesium iron silicate (FMIS) has a mean diameter between about 10 μm and 40 μm.

In some implementations the coarse magnesium iron silicate (CMIS) has a mean diameter between about 150 am and 500 μm.

In some implementations the ultrafine magnesium iron silicate (UFMIS) has a mean diameter between about 1 μm and 15 μm.

In an embodiment, the content of FMIS is of at least 3 wt. % of the composition, and/or the content of CMIS is of at least 10 wt. % of the composition, and/or the content of UFMIS is of at least 0.2 wt. % of the composition.

In an embodiment, the cement includes particles smaller than about 100 μm.

In an embodiment, the binder system includes super sulphated cement (SSC), silica fume, and chemical activator e.g. MgO or calcium formate.

In some implementations the silica fume is present in an amount from 5-20 wt. %, from 5-15 wt. %, or 7.5-12.5 wt. %.

In an embodiment, the cement is a high-sulfate resistance (HS) cement or a low heat (LH) cement, or a combination thereof.

In an embodiment, the content of FMIS ranges from about 5-70 wt. % of the cement content, from about 5-50 wt. % of the cement content, from about 5-25 wt. % of the cement content, from about 25-70 wt. % of the cement content, or from about 5-10 wt. % of the cement content.

In an embodiment, the FMIS includes particles smaller than about 140 μm, for example about 10-140 μm. In some implementations the FMIS has a mean diameter between about 10 μm and 20 μm.

In some implementations, the CMIS includes particles smaller than about 1000 μm, for example about 140-1,000 μm. In some implementations the CMIS has a mean diameter between about 200 am and 450 μm.

In some implementations, the UFMIS includes particles smaller than about 10 μm, e.g., from about 0.01-10 μm. In some implementations the UFMIS has a mean diameter between about 1 am and 5 μm.

In some implementations, the content of carbonated MIS material ranges between 5 wt. % and 40 wt. % of the cement content.

In some implementations the aggregate is a mixture of magnesium iron silicate (i.e., CMIS, FMIS, and/or UFMIS) and at least one other material. In some implementations the aggregate includes quartz power, quartz sand, or a combination thereof. When the aggregate include additional materials, the ratio of additional materials to magnesium iron silicate can be from 5:1 to 1:5, from 2.5:1 to 1:2.5, from 1.5:1 to 1:1.5, from 1.5:1 to 1:1, from 2.5:1 to 1:1, from 5:1 to 1:1, from 1:1 to 1:1.5, from 1:1 to 1:2.5, or from 1:1 to 1:5.

In some implementations, the reactive pozzolanic material includes silica fume.

In some implementations, the silica fume includes particles between about 0.10 μm and about 0.20 μm.

In some implementations, the superplasticizer includes polyacrylate.

In some implementations, the composition includes between about 15 wt. % and about 45 wt. % of cement.

In some implementations the composition includes CMIS in an amount from about 0-60 wt. %, from about 15-60 wt. %, from about 0-45 wt. %, from about 5-15 wt. %, from about 10-25 wt. %, from about 15-35 wt. %, from about 20-45 wt. %, or from about 30-45 wt. %

In some implementations the composition includes between about 5 wt. % and about 10 wt. % of reactive pozzolanic material.

In some implementations the composition includes FMIS in an amount from about 0-30 wt. %, from about 3-30 wt. %, from about 3-20 wt. %, from about 3-15 wt. %, from about 5-15 wt. %, or from about 7.5-12.5 wt. %.

In some implementations the composition includes UFMIS in an amount from about 0-10 wt. %, from about 0.3-10 wt. %, from about 0.3-5 wt. %, from about 0.3-2.5 wt. %, from about 1-10 wt. %, from about 1-5 wt. %, from about 2.5-5 wt. %, from about 2.5-7.5 wt. %, or from about 5-10 wt. %.

In some implementations the composition can include CMIS and FMIS, and optionally UFMIS as well. In some implementations the composition includes CMIS in an amount from 25-50 wt. %, and FMIS in an amount from 5-15 wt. %.

In some implementations the composition includes between about 0.2 wt. % and about 4 wt. % of superplasticizer. In some implementations the SST-UHPC includes fibers, for example steel fibers, glass fibers, synthetic fibers, natural fibers, or a combination thereof. The fibers can have a diameter of less than 0.3 μm, or greater than 0.3 μm. In some implementations the fibers include a mixture of different types of fiber and/or a mixture of fibers having diameter less than 0.3 μm and fibers having a diameter greater than 0.3 μm.

In certain implementations the composition does not include fibers. In some implementations the composition does not include glass fibers. In some implementations the composition does not include steel fibers. In some implementations the composition does not include synthetic fibers. In some implementations the composition does not include natural fibers.

In some implementations the SST-UHPC includes between about 3 wt. % and about 12 wt. % of water.

In some implementations the amount of CMIS+FMIS+UFMIS is greater than or equal to about 12 wt. %, greater than or equal to 14 wt. %, greater than or equal to 16 wt. %, greater than or equal to 18 wt. %, greater than or equal to 20 wt. %, or greater than or equal to 25 wt. %. In some implementations the sum of CMIS+FMIS+UFMIS is from 15-60 wt. %, from 15-50 wt. %, from 20-50 wt. %, from 25-50 wt. %, from 30-50 wt. %, from 30-60 wt. %, from 40-60 wt. %, from 25-50 wt. %, from 20-45 wt. %, from 20-40 wt. %, from 20-35 wt. %, from 20-30 wt. %, or from 25-30 wt. %.

In an embodiment, the content of FMIS is of at least 2 wt. % of the SST-UHPC, and/or a content of CMIS is of at least 20 wt. % of the SST-UHPC, and/or a content of UFMIS is of at least 0.5 wt. % of the SST-UHPC.

Disclosed herein are concrete compositions including a binder, magnesium iron silicate; and optionally a quartz powder or sand. In some implementations the binder includes silica fume, magnesium oxide, and super-sulphated cement. In some implementations the binder can be HS cement.

In some implementations the compositions do not include quartz powder. In some implementations the composition does not include quartz sand. In some implementations the composition does not include either quartz powder or quartz sand.

### Magnesium Iron Silicate

In some implementations the magnesium iron silicate can be present in an amount, relative to the binder, from 80-180 wt. %, from 100-120 wt. %, from 140-180 wt. %, from 160-180 wt. %, from 80-100 wt. %, from 80-120 wt. %, from 80-140 wt. %, from 80-160 wt. %, from 100-120 wt. %, from 110-130 wt. %, from 120-140 wt. %, or from 130-150 wt. %.

In certain implementations the magnesium iron silicate can have a particle size distribution greater than 500 μm, greater than 600 μm, greater than 650 μm, greater than 700 μm, or greater than 750 μm. In some implementations the magnesium iron silicate can have a mean PSD at d₅₀ from 200-500 μm, from 250-500 μm, from 300-500 μm, from 350-500 μm, from 400-500 μm, from 200-300 μm, from 300-400 μm, from 250-350 μm, or from 350-450 μm. The particle size distribution may be determined according to ASTM C33/C33M.

In certain implementations the magnesium iron silicate can have a specific gravity from 2.5-5 g/cm³, from 3.0-5 g/cm³, from 3.5-5 g/cm³, from 2.5-3.5 g/cm³, from 2.5-3.0 g/cm³, from 3.0-3.5 g/cm³, or from 3.0-4.0 g/cm³.

In certain implementations, the magnesium iron silicate can include SiO₂ in an amount (relative to the magnesium iron silicate in total) that is from 30-50 wt. %, from 30-40 wt. %, from 35-50 wt. %, from 40-50 wt. %, from 45-50 wt. %, from 30-35 wt. %, from 35-45 wt. %, from 35-40 wt. %, or from 40-45 wt. %.

In certain implementations, the magnesium iron silicate can include MgO in an amount (relative to the magnesium iron silicate in total) that is from 30-50 wt. %, from 30-40 wt. %, from 35-50 wt. %, from 40-50 wt. %, from 45-50 wt. %, from 30-35 wt. %, from 35-45 wt. %, from 35-40 wt. %, or from 40-45 wt. %.

In certain implementations, the magnesium iron silicate can include FeO in an amount (relative to the magnesium iron silicate in total) that is from 5-20 wt. %, from 5-15 wt. %, from 5-10 wt. %, from 10-25 wt. %, from 10-20 wt. %, from 10-15 wt. %, from 15-20 wt. %, from 15-25 wt. %, or from 20-25 wt. %.

In certain implementations, the magnesium iron silicate can include Fe₂O₃ in an amount (relative to the magnesium iron silicate in total) that is from 5-20 wt. %, from 5-15 wt. %, from 5-10 wt. %, from 10-25 wt. %, from 10-20 wt. %, from 10-15 wt. %, from 15-20 wt. %, from 15-25 wt. %, or from 20-25 wt. %.

In certain implementations the magnesium iron silicate does not include TiO₂.

In certain implementations, the magnesium iron silicate can include SiO₂ and Mg in an amount (relative to the magnesium iron silicate in total) that is from 60-95 wt. %, from 70-95 wt. %, from 80-95 wt. %, from 85-95 wt. %, from 60-70 wt. %, from 65-75 wt. %, from 70-80 wt. %, from 75-85 wt. %, from 80-90 wt. %, or from 85-95 wt. %.

In certain implementations the magnesium iron silicate includes less than 0.25% Cr₂O₃.

In some implementations, the magnesium iron silicate can be derived from magnesium silicate rocks, for example magnesium silicate rock mine tailings. In some implementations the magnesium iron silicate is derived from Twin Sisters dunite, Yoko-Dovyren dunite, Aheim-75 dunite, Aheim-120 dunite, or a combination thereof.

### Binders

In certain aspects, the binder can include cement. For example, the cement can include Portland cement, a basic ingredient of concrete, mortar, stucco, and non-specialty grout, which is a fine powder produced by heating limestone and clay minerals in a kiln to form clinker, grinding the clinker, and adding small amounts of other materials. Several types of Portland cement can be used, for example, API Class A, Class G, or Class H; Ordinary Portland Cement (OPC) Type I, Type II, Type III, Type IV, or Type V; or a combination thereof (in accordance with the ASTM C150 standard). Portland Cement Type Ia, Type IIa, and/or Type IIIa may also be used, which have the same composition as Types I, II, and III except that an air-entraining agent is ground into the mix (also in accordance with the ASTM C150 standard).

Yet in other aspects, the cement can include hydraulic types of cement, Saudi Class G hydraulic cement, non-hydraulic types of cement, Portland fly ash cement, Portland Pozzolan cement, Portland silica fume cement, masonry types of cement, mortars, EMC types of cement, stuccos, plastic types of cement, expansive types of cement, white blended types of cement, Pozzolan-lime types of cement, slag-lime types of cement, supersulfated types of cement, calcium aluminate types of cement, calcium sulfoaluminate types of cement, geopolymer types of cement, Rosendale types of cement, polymer cement mortar, lime mortar, and/or pozzolana mortar.

It is understood that the cement can include a mixture of two or more different types of cement. For example, the cement can include a mixture of hydraulic cement and non-hydraulic cement. Yet, in other aspects, the cement can include mixtures of different hydraulic cements and/or different non-hydraulic cements.

In still further aspects, the binder can include a cementitious material. In such aspects, the cementitious material can include silica fume, fly ash, metakaolin, bentonite, slag rice husk ash, calcined shale, or any combination thereof.

In certain implementations the binder includes super sulphated cement. In such exemplary and unlimiting aspects, the super sulphated cement can include calcium sulfate, Portland cement, and slag. For example, calcium sulphate can be present in an amount (relative to the super sulfate cement) from 5-25 wt. %, 7-25 wt. %, 10-25 wt. %, 15-25 wt. %, 5-20 wt. %, 5-15 wt. %, 5-10 wt. %, preferably 10-20 wt. %. In some implementations the super sulphated cement can include Portland cement in an amount from 0.1-10 wt. %, 0.5-10 wt. %, 1-10 wt. %, 5-10 wt. %, 0.1-7 wt. %, 0.1-5 wt. %, preferably 1-5 wt. %. The super sulphated cement can include the slag in an amount form 65-90 wt. %, 70-90 wt. %, 80-90 wt. %, 65-85 wt. %, 70-85 wt. %, preferably 75-85 wt. %. Exemplary slags include ground granulated blast-furnace slag (“GGBFS”). The binder can include the super sulphated cement in an amount (relative to the total binder) from 40-90 wt. %, from 50-90 wt. %, from 60-90 wt. %, from 70-90 wt. %, from 80-90 wt. %, from 40-60 wt. %, from 50-60 wt. %, from 45-65 wt. %, from 50-75 wt. %, from 55-65 wt. %, from 55-70 wt. %, from 55-70 wt. % from 55-80 wt. %, from 60-75 wt. %, from 60-70 wt. %, from 60-65 wt. %, or from 60-85 wt. %.

In certain implementations, the cement is present in an amount from 25-45 wt. %, from 30-45 wt. %, from 30-40 wt. %, or from 32.5-37.5 wt. %.

In certain implementations when magnesium oxide is present in the binder, it can be present in an amount (relative to the total binder) that is from 1-15 wt. %, from 1-10 wt. %, from 1-5 wt. %, from 2.5-7.5 wt. %, from 5-10 wt. %, or from 10-15 wt. %.

In certain implementations when silica fume is present in the binder, it can be present in an amount (relative to the total binder) that is from 15-45 wt. %, from 20-45 wt. %, from 25-45 wt. %, from 30-45 wt. %, from 35-45 wt. %, from 20-30 wt. %, from 25-35 wt. %, from 15-25 wt. %, or from 30-40 wt. %.

### Quartz Powder

In still further aspects, the composition can include an amount of aggregates. It is understood that the aggregates can be classified based on the aggregate size as very fine, fine, and coarse. In some implementations the composition can include MIS and a further aggregate material. In some implementations, the composition includes MIS as the only aggregate material. In some implementations, the composition includes course MIS (CMIS), fine MIS (FMIS), and/or ultrafine MIS (UFMIS). In some implementations, the composition includes only CMIS and FMIS as the only aggregate material. In some implementations, the composition includes only CMIS, FMIS, and UFMIS as the only aggregate material.

In such exemplary and unlimiting aspects, the composition can include ultrafine aggregates having an average particle size less than or equal to 250 μm, less than or equal to 225 μm, less than or equal to 200 μm, less than or equal to 175 μm, less than or equal to 150 μm, less than or equal to μm, less than or equal to 125 μm, less than or equal to 100 μm, less than or equal to 75 μm, or less than or equal to 50 μm.

In still further aspects, the composition can include fine aggregates having an average particle size less than or equal to 600 μm, less than or equal to 575 μm, less than or equal to 550 μm, less than or equal to 525 μm, less than or equal to 500 μm, less than or equal to μm, less than or equal to 475 μm, less than or equal to 450 μm, less than or equal to 425 μm, less than or equal to 400 μm, less than or equal to 375 μm, less than or equal to 350 μm, less than or equal to 325 μm, less than or equal to 300 μm, less than or equal to 275 μm, or less than or equal to 250 μm.

In still further aspects, the composition can include coarse aggregates having an average particle size less than or equal to 4.75 mm, less than or equal to 4.5 mm, less than or equal to 4.25 mm, less than or equal to 4 mm, less than or equal to 3.75 mm, less than or equal to 3.5 mm, less than or equal to 3.25 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 900 μm, less than or equal to 800 μm, less than or equal to 700 μm, less than or equal to 600 μm.

It is understood that aggregates themselves can be obtained from any known materials useful in concrete articles. For example, the aggregates can comprise river sand, masonry sand, limestone sand, lightweight porous sand, granite sand, quartz sand, silica sand, or any combination thereof.

In some aspects, the aggregates used in the disclosed herein composition can include a quartz powder. In some implementations, the quartz powder has a size distribution of less than 100 μm, or less than 50 μm. In certain implementations, the quartz powder has a mean PSD at d₅₀ of less than 100 μm, less than 75 μm, less than 50 μm, less than 40 μm, less than 30 μm, less than 20 μm, or less than 10 μm. In certain implementations, less than 1 wt. % of the quartz power has a particle size greater than 150 μm.

In some implementations the quartz powder is present in an amount, relative to the binder, that is from 0.1-0.5 wt. %, from 0.2-0.5 wt. %, from 0.3-0.5 wt. %, from 0.4-0.5 wt. %, from 0.1-0.2 wt. %, from 0.15-0.25 wt. %, from 0.2-0.3 wt. %, from 0.25-0.35 wt. %, from 0.3-0.4 wt. %, 0.35-0.45 wt. %, or from 0.4-0.5 wt. %.

In certain implementations the quartz powder includes less than 1 wt. % of quartz (relative to the total quartz powder) having a particle size greater than 150 μm.

In still further aspects, if desired the disclosed herein compositions can also include reinforcing elements. For example, and without limitations, the composition can include metal materials, polymeric materials, carbon materials, a mineral material such as basalt or glass, a natural material such as wood based, or any combination thereof. In yet still further aspects, the reinforcing elements can be present as fibers, particles, and the like.

In still further aspects, the composition can further include an amount of active agents and/or reagents, fillers, or any combination thereof. In such exemplary and unlimiting aspects, the active agent and/or reagent can include a water reducer, a set retarder, a shrinkage-reducing admixture, a workability retaining admixture, viscosity adjusting admixture, or any combination thereof. Some unlimiting examples of agents/reagents include Sika ViscoCrete-2110, SikaControl NS, Sika Stabilizer-300 SCC, Sika Stabilizer-4 R, Master Builders Solutions MasterLife CFA 007 and MasterLife SRA 035. If the active agents and/or reagents are present in such aspects, the amount of those materials can be greater than zero to less than 0.15, less than 0.12, less than 0.1, less than 0.08, less than 0.05, less than 0.01 parts by weight based on the weight of binder composition. In certain aspects, the amount of the agents and/or reagents can be between 0.001 to less than 0.15, 0.005 to less than 0.15, 0.01 to less than 0.15, 0.05 to less than 0.15, 0.1 to less than 0.15, 0.001 to less than 0.12, 0.001 to less than 0.1, 0.001 to less than 0.08, 0.001 to less than 0.05, 0.001 to less than 0.01 parts by weight based on the weight of the composition.

In still further aspects, the composition includes water to cement (w/c) or water to binder (w/b) ratio of 0.1 to less than 0.35, for example from 0.1-0.3, 0.1-0.25, 0.1-0.2, 0.1-0.15. 0.15-0.3, 0.15-0.25, 0.15-0.2, 0.2-0.3, or 0.25-0.3.

Also disclosed are methods of preparing concrete articles using the disclosed compositions. In some implementations the method includes mixing the disclosed compositions with an amount of water to form a slurry, wherein a weight ratio of water to the binder composition is as disclosed above. In certain implementations, the weight ratio of water to binder is from 1:0.1-1:0.5, 1:0.15-1:0.5, 1:0.15-1:0.4, 1:0.2-1:0.4, 1:0.2-1:0.3, 1:0.2-1:0.25, or 1:0.25-1:0.3.

In still further aspects, disclosed herein is a concrete article prepared from the disclosed herein composition.

In still further aspects, the article can exhibit a compressive strength (prepared, cured, and tested according to ASTM C109) of 5 MPa to 50 MPa, 5 MPa to 45 MPa, 5 MPa to 40 MPa, 5 MPa to 35 MPa, 5 MPa to 30 MPa, 5 MPa to 25 MPa, 5 MPa to 20 MPa, 5 MPa to 15 MPa, 10 MPa to 50 MPa, 20 MPa to 50 MPa, 30 MPa to 50 MPa, 40 MPa to 50 MPa, and so on.

### EXAMPLES

The following examples are for the purpose of illustration of the invention only and are not intended to limit the scope of the present invention in any manner whatsoever.

### Example 1—Materials Characterization

Powder

| | Type V | | Silica | Quartz | |
|---|---|---|---|---|---|
| Identification | Cement | GGBFS | Fume | Powder | MISP66 |
| Silicon dioxide (SiO₂) | 21.5 | 34.8 | 99.8 | 99.8 | 41.6 |
| Iron oxide (Fe₂O₃) | 4.8 | 0.78 | 0.09 | 0.09 | 7.6 |
| Aluminum oxide | 3.1 | 13.99 | 0.11 | 0.11 | 0.3 |
| (Al₂O₃) | | | | | |
| Calcium oxide (CaO) | 64.2 | 30.06 | 0.4 | 0.38 | — |
| Titanium dioxide | — | 0.55 | — | 0.25 | — |
| (TiO₂) | | | | | |
| Sulfur trioxide (SO₃), | 2.8 | 0.92 | — | 0.53 | — |
| Magnesium oxide | 2..4 | 6.03 | 0.2 | 0.2 | 49.3 |
| (MgO) | | | | | |
| Sodium oxide (Na₂O) | 0.22 | 0.19 | 0.2 | 0.25 | — |
| Potassium Oxide | — | 0.44 | 0.5 | 3.5 | — |
| (K₂O) | | | | | |
| Nikel oxide (NiO) | — | — | — | — | 0.32 |
| Manganese (MnO) | — | 0.23 | 0.25 | — | 0.09 |
| Chromic oxide (SO₃), | — | — | — | — | 0.77 |
| Loss on ignition (LOI) | 1.2 | 0.6 | 3.5 | 0.32 | 0.6 |
| C₃S | 63 | — | — | — | — |
| C₂S | 8.7 | — | — | — | — |
| C₃A | 0.1 | — | — | — | — |
| C₄AF | 15 | — | — | — | — |

Aggregate

| Identification | Quartz Sand | MIS400 | MIS140 |
|---|---|---|---|
| Silicon dioxide (SiO₂) | 99.65 | 42.5 | 41.6 |
| Iron oxide (Fe₂O₃) | 0.018 | 8.3 | 7.6 |
| Aluminum oxide (Al₂O₃) | 0.07 | 0.18 | 0.3 |
| Calcium oxide (CaO) | 0.01 | 0.14 | — |
| Titanium dioxide (TiO₂) | 0.01 | — | — |
| Sulfur trioxide (SO₃), | — | — | — |
| Magnesium oxide (MgO) | — | 48 | 49.3 |
| Sodium oxide (Na₂O) | — | 0.02 | — |
| Potassium Oxide (K₂O) | — | 0.01 | — |
| Nikel oxide (NiO) | — | 0.35 | 0.32 |
| Manganese (MnO) | — | — | 0.09 |
| Chromic oxide (SO₃), | — | 0.13 | 0.77 |
| Loss on ignition (LOI) | 0.07 | 1 | 0.6 |
| Price/ton | — | 574 | 648 |

Physical properties

| | Powder | | | | |
|---|---|---|---|---|---|
| | Type V | | Silica | Quartz | |
| Identification | Cement | GGBFS | Fume | Powder | MISP66 |
| Specific gravity | 3.31 | 2.89 | 2.2 | 2.6 | 3.24 |
| Blaine surface area | 318 | 480 | 20,000 | — | — |
| (m²/kg) | | | | | |
| Mean particle size, | 11 | 11 | 0.15 | 14 | 66 |
| d₅₀, (μm) | | | | | |
| Maximum-particle | — | — | — | — | — |
| size, dₘₐₓ, (μm) | | | | | |

| | Rock | | |
|---|---|---|---|
| | Quartz Sand | MIS400 | MIS140 |
| Specific gravity | 2.65 | 3.26 | 3.24 |
| Blaine surface area (m²/kg) | — | — | — |
| Mean particle size, d₅₀, (μm) | 300 | 400 | 66 |
| Maximum-particle size, dₘₐₓ, (μm) | 600 | 850 | — |

### Example 2: Concrete Compositions

QS replacement with MIS in UHPC.

| | | Series I (MS Grading Selection) | |
|---|---|---|---|
| Material | Ref. | 100MIS140 | 100MIS400 |
| Type HS Cement | 790 | 846 | 847 |
| Silica Fume | 220 | 235 | 235 |
| Water | 183 | 195 | 196 |
| Water-to-binder ratio (w/b) | 0.20 | 0.20 | 0.20 |
| Quartz sand | 949 | — | -— |
| MIS sand | — | 1015 | 1017 |
| Quartz powder | 237 | 254 | 254 |
| Solid content in HRWRA | 12.9 | 13.8 | 13.9 |

QS replacement with MIS in UHPC

| | Series II (Effect of MS Content) | | | |
|---|---|---|---|---|
| Material | 25MIS400 | 50MIS400 | 75MIS400 | 100MIS400 |
| Type HS Cement | 804 | 818 | 832 | 847 |
| Silica Fume | 223 | 227 | 231 | 235 |
| Water | 186 | 189 | 192 | 196 |
| Water-to-binder | 0.20 | 0.20 | 0.20 | 0.20 |
| ratio (w/b) | | | | |
| Quartz sand | 724 | 491 | 250 | — |
| MIS sand | 241 | 491 | 749 | 1017 |
| Quartz powder | 241 | 245 | 250 | 254 |
| Solid content in | 13.1 | 13.4 | 13.6 | 13.9 |
| HRWRA | | | | |

QS replacement with MSP in UHPC.

| | MSP (d₅₀ = 66 μm) | | | | |
|---|---|---|---|---|---|
| | | | 50 | 75 | 100 |
| Material | Ref. | 25MISP66 | MISP66 | MISP66 | MISP66 |
| Type HS Cement | 790 | 794 | 798 | 801 | 805 |
| Silica Fume | 220 | 221 | 222 | 223 | 224 |
| Water | 183 | 183 | 184 | 185 | 186 |
| Water-to-binder | 0.20 | 0.20 | 0.20 | 0.20 | 0.20 |
| ratio (w/b) | | | | | |
| Quartz sand | 949 | 953 | 957 | 962 | 966 |
| Dunite sand | — | — | — | — | — |
| Quartz powder | 237 | 179 | 120 | 60 | — |
| Dunite powder | — | 60 | 120 | 180 | 241 |
| Solid content in | 12.9 | 13.0 | 13.0 | 13.1 | 13.2 |
| HRWRA | | | | | |

Mixes to study the synergetic effect of
substituting QS with MIS and QP with MSP.

| | | Synergetic effect | | |
|---|---|---|---|---|
| | | 50CMIS- | 100CMIS- | 100CMIS- |
| | | 50FMIS/ | 25FMIS/ | 100FMIS/ |
| Material | Ref. | 50QS-50QP | 0QS-75QP | 0QS-0QP |
| Type HS Cement | 790 | 826 | 851 | 864 |
| Silica Fume | 220 | 229 | 236 | 240 |
| Water | 183 | 191 | 197 | 200 |
| Water-to-binder | 0.20 | 0.20 | 0.20 | 0.20 |
| ratio (w/b) | | | | |
| Quartz sand | 949 | 495 | — | — |
| Dunite sand | — | 495 | 1022 | 1037 |
| Quartz powder | 237 | 124 | 192 | — |
| Dunite powder | — | 124 | 64 | 259 |
| Solid content in | 12.9 | 13.5 | 13.9 | 14.1 |
| HRWRA | | | | |

Cement replacement with SSC in UHPC.

| | | SSC-UHPC | |
|---|---|---|---|
| Material | Ref. | 79S/20A/1C | 83S/15A/2C |
| Type HS Cement | 790 | 8 | 15 |
| GGBFS | — | 602 | 632 |
| Anhydrate | — | 152 | 114 |
| Silica Fume | 220 | 212 | 211 |
| Water | 183 | 176 | 176 |
| Water-to-binder ratio (w/b) | 0.20 | 0.20 | 0.20 |
| Quartz sand | 949 | 914 | 914 |
| Quartz powder | 237 | 228 | 229 |
| Solid content in HRWRA | 12.9 | 12.5 | 12.5 |

### Example 3: Fresh Properties

Fresh properties of MIS-UHPC.

| | | Characteristics | | |
|---|---|---|---|---|
| | | Slump | | Air |
| | | Flow, | Density, | Content, |
| Series | Mixture | mm | kg/m³ | % |
| Control | Reference | 186 | 2367 | 1.8 |
| Series I (QS | 25CMIS/75QS | 188 | 2403 | 2.0 |
| replacement) | 50CMIS/50QS | 193 | 2439 | 2.2 |
| | 75CMIS/25QS | 190 | 2479 | 2.3 |
| | 100CMIS/0QS | 185 | 2534 | 1.9 |
| Series II (QP | 25FMIS/75QP | 165 | 2338 | 3.4 |
| replacement) | 50FMIS/50QP | 160 | 2354 | 3.2 |
| | 75FMIS/25QP | 158 | 2372 | 2.9 |
| | 100FMIS/0QP | 153 | 2359 | 3.9 |
| Series III | 50CMIS-50FMIS/ | 168 | 2407 | 4.4 |
| (synergetic | 50QS-50QP | | | |
| effect) | 100CMIS-25FMIS/ | 165 | 2459 | 5.3 |
| | 0QS-75QP | | | |
| | 100CMIS-100FMIS/ | 170 | 2515 | 4.5 |
| | 0QS-OQP | | | |

### Example 4: Compressive Strength

Fresh properties of SSC-UHPC.

| | | Characteristics | | | |
|---|---|---|---|---|---|
| | | HRWR | Slump | Density, | Air |
| Series | Mixture | % | Flow, mm | kg/m³ | Content, % |
| UHPC | Reference | 1.5 | 186 | 2367 | 1.8 |
| | 79S-20A-1C | 1.5 | 140 | 2290 | 1.4 |
| | 83S-15A-2C | 1.5 | 143 | 2285 | 1.7 |

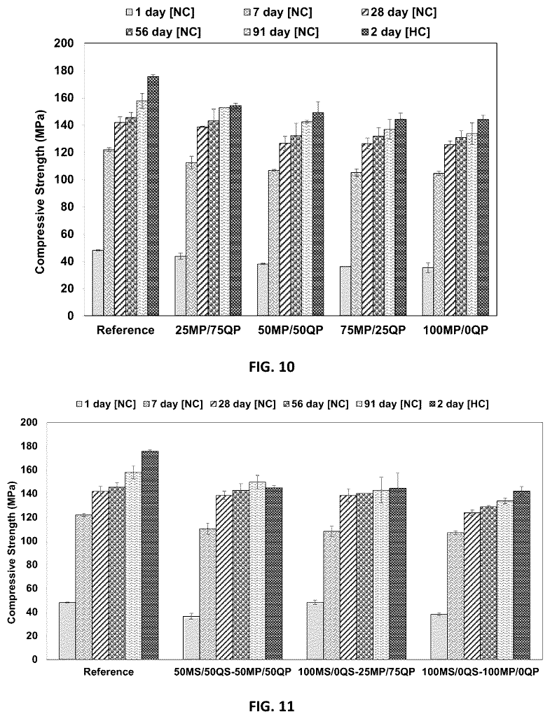

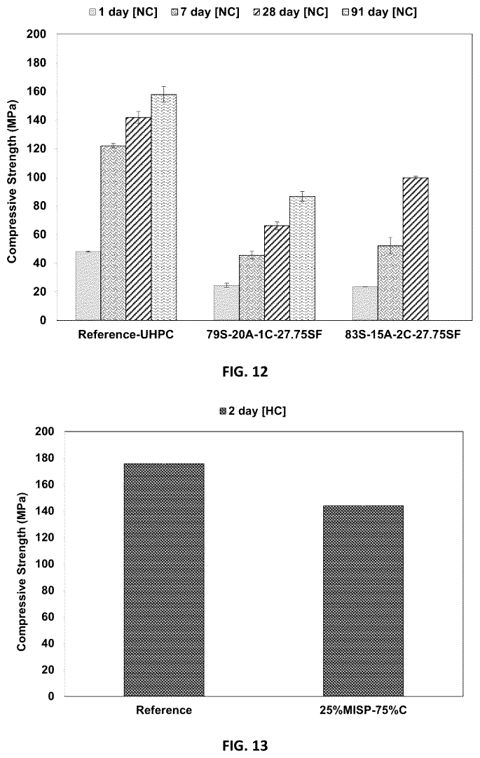

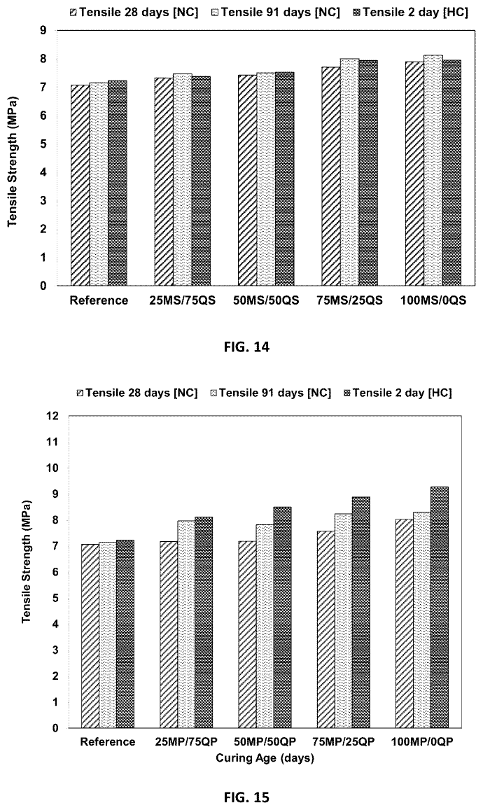

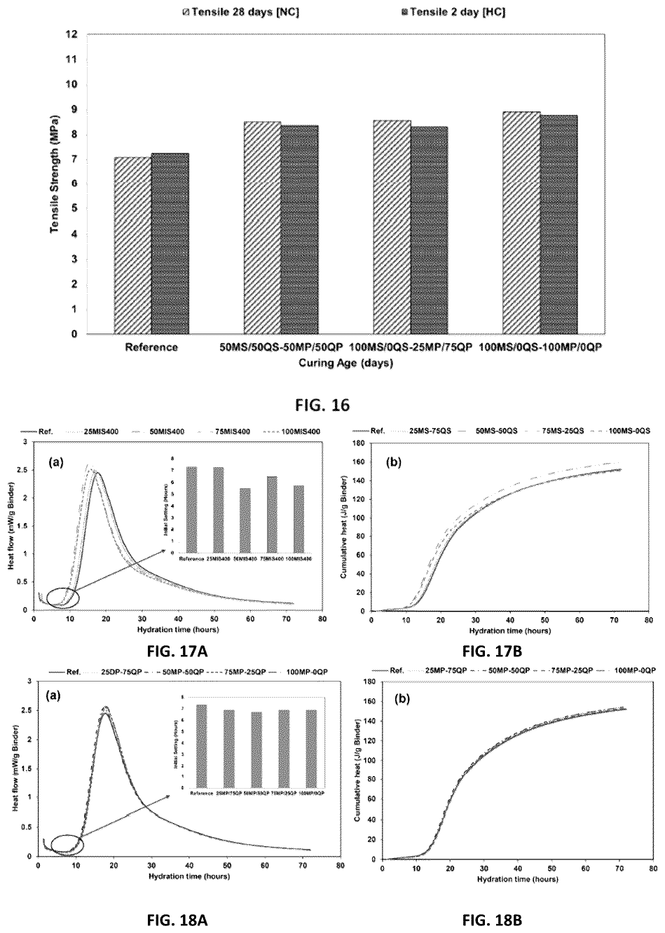

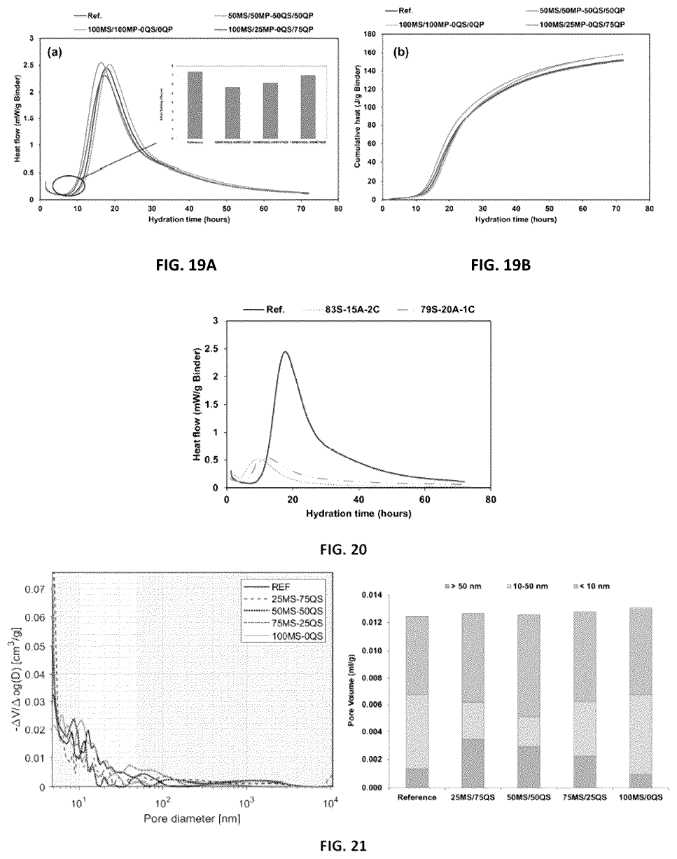

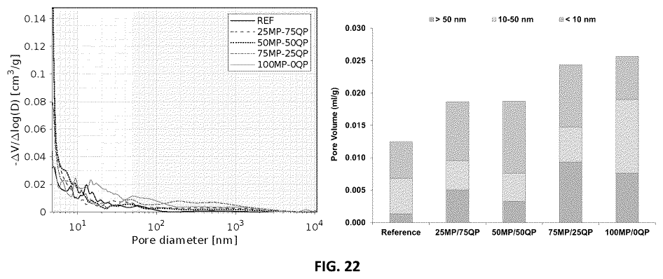

The compressive strength of UHPC mixtures, incorporating MIS and MISP as a replacement for QS and QP respectively, was evaluated under two different curing regimes. These included normal curing (NC) at 1, 7, 28, 56, and 91 days, and hot curing (HC) for 48 hours, as shown in FIGS. 9, 10, and 11. The results indicate a consistent increase in compressive strength with higher MIS content across all ages, replacement levels, and curing regimes. For example, in the 100MS-0QS mixture, the compressive strength increased by 5% compared to the reference mixture after 48 hours of hot curing. Additionally, under normal curing, the mixture with 50% MIS-50% QS replacement showed an increase in compressive strength of 3% at 28 days and 5% at 91 days, respectively, compared to the control mixture.

The enhancement in compressive strength with increasing MIS content can be attributed to the surface roughness of MIS particles compared to the smoother surface of QS. The rougher texture of MIS improves mechanical interlocking and frictional resistance between the aggregate and the cement matrix, contributing to stronger bonding and enhanced mechanical performance. Furthermore, the incorporation of MIS increases the packing density of the matrix, improving the overall microstructure of the UHPC. Both QS and MIS have the same Mohs Hardnes of 7, which is proposed to be reflected to similar hard inclusion. Additionally, the higher density of MIS relative to QS (3.2 and 2.65, respectively) results in denser weight UHPC samples.

The results show that the replacement of QP with MSP leads to a slight reduction in compressive strength compared to the reference mixture across both NC and HC regimes. For instance, the 100MP-0QP mixture achieved a compressive strength of approximately 144 MPa after 48 hours of hot curing, which represents an 18% reduction compared to the reference mixture. Furthermore, under normal curing, the mixture with 25MP-75QP show a slight reduction in compressive strength, 2% and 3% at 28 and 91 days, respectively, compared to the control mixture. Interestingly, beyond 25% replacement, the reduction becomes consistent across all ages and curing regimes, with compressive strength stabilizing at lower values as the replacement percentage increases.

This reduction in strength can be attributed to the larger d50 particle size and the mono-sized particle size distribution (PSD) of MP compared to QP. These factors reduce the packing density and increase the porosity of the matrix, both of which negatively impact compressive strength. The decreased packing efficiency limits the material's ability to form a dense microstructure, thereby reducing the overall mechanical performance of the UHPC. MP is an inert material in the alkaline environment of cement-based materials (pH 10 to 13), and the low w/b ratio and dense microstructure of UHPC hinder any CO₂ dissolution which limit carbonation reactivity of MP. There for the reduction in strength is proposed to be mainly due to physical effect of the PSD on the micromechanics of UHPC.

The synergetic effect of both replacing QS and QP with CMIS and FMIS respectively, showed that reduction effect of FMIS is dominant on the compressive strength as 19% reduction was measured in the 100CMIS/0QS-100FMIS/0QP mixture as the value of compressive strength reduced to 142 MPa compared to the reference mixture of 175 MPa, this reduction is also attributed to the effect of FMIS in reducing the packing density with affect the compressive strength.

This reduction in strength is due to the utilization of MSP to replace QP as shown in Paper, the reduction is due to MSP particle size which affect the packing density of UHPC, as the particles large particle size and being mono sized reduce the effect of filling the micro gaps which results in reduction in packing density.

| | | Series I (QS replacement) | | | |
|---|---|---|---|---|---|
| | | 25MS/ | 50MS/ | 75MS/ | 100MS/ |
| Material | Reference | 75QS | 50QS | 25QS | 0QS |
| 1 day [NC] | 48.01 | 46.48 | 45.67 | 49.16 | 46.94 |
| 7 day [NC] | 121.92 | 121.35 | 123.90 | 125.08 | 127.30 |
| 28 day [NC] | 141.79 | 142.56 | 146.25 | 148.51 | 151.09 |
| 56 day [NC] | 145.37 | 145.91 | 146.18 | 148.22 | 152.96 |
| 91 day [NC] | 157.77 | 159.85 | 166.27 | 166.74 | 167.63 |
| 2 day [HC] | 175.63 | 176.88 | 182.25 | 182.50 | 183.96 |

| | | Series II (QP replacement) | | | |
|---|---|---|---|---|---|
| | | 25MP/ | 50MP/ | 75MP/ | 100MP/ |
| Material | Reference | 75QP | 50QP | 25QP | 0QP |
| 1 day [NC] | 48.01 | 43.63 | 38.01 | 36.04 | 35.25 |
| 7 day [NC] | 121.92 | 112.45 | 106.69 | 105.10 | 104.52 |
| 28 day [NC] | 141.79 | 138.57 | 126.51 | 126.40 | 125.62 |
| 56 day [NC] | 145.37 | 143.06 | 132.18 | 131.91 | 130.76 |
| 91 day [NC] | 157.77 | 152.72 | 142.47 | 136.79 | 133.62 |
| 2 day [HC] | 175.63 | 154.24 | 149.10 | 144.30 | 144.13 |

| | | Series III (synergetic effect) | | |
|---|---|---|---|---|
| | | 50MS/50QS- | 100MS/0QS- | 100MS/0QS- |
| Material | Reference | 50MP/50QP | 25MP/75QP | 100MP/0QP |
| 1 day [NC] | 48.01 | 36.43 | 48.19 | 37.99 |
| 7 day [NC] | 121.92 | 110.36 | 108.07 | 106.90 |
| 28 day [NC] | 141.79 | 138.34 | 138.33 | 123.84 |
| 56 day [NC] | 145.37 | 142.58 | 140.00 | 128.83 |
| 91 day [NC] | 157.77 | 149.58 | 142.82 | 133.83 |
| 2 day [HC] | 175.63 | 144.91 | 144.37 | 142.18 |

The compressive strength of SCC-UHPC mortars was evaluated using 2 different compositions of GGBFS, anhydrate and cement at the age of 1, 7, 28, and 91 days of NC and 2 days of HC. The results indicate an increase in compressive strength with higher GGBFS content. Both SSC-UHPC samples recorded a reduction in strength when compared to reference UHPC mixtures after 28 days of NC, the sample 83S/15A/2C achieved a lower reduction of 30% while the 79S/20A/1C mixture recorded a higher 50%.

Without being bound by any particular theory, the reduction in strength in both samples is believed to be due to the alternation of hydration products shifting to the formation of the weaker ettringite instead of C-S-H, which result in reduction in strength specially at early ages. The increase in compressive strength in the higher GGBFS content samples is related to the higher hydraulically active slag content, as slags with higher basicity are deemed highly reactive and can react without an alkaline activator. The reason behind the reduction in strength in the 79S/20A/1C could be due to the increase in the anhydrate content, which induce a rise in sulfate concentration as a result of anhydrite dissolution in the pore solution, which affects the growth and precipitation of ettringite, which is the main product of SSC hydration and main source of strength at the first 7 days.

| | UHPC | | |
|---|---|---|---|
| | | 79S-20A-1C- | 83S-15A-2C- |
| Material | Reference-UHPC | 27.75SF | 27.75SF |
| 1 day [NC] | 48.01 | 24.49 | 23.38 |
| 7 day [NC] | 121.92 | 45.53 | 52.03 |
| 28 day [NC] | 141.79 | 66.04 | 99.65 |
| 91 day [NC] | 157.77 | 86.55 | 0.00 |
| 2 day [HC] | 175.63 | 75.32 | 70.90 |

### Example 5: Heat of Hydration

Heat of hydration values for the SSC paste mixtures were studied for 6 days at 23° C. using the TAM Air isothermal calorimeter according to ASTM C1679, heat of hydration of SCC was found to be less than the heat of hydration of normal cement which follows the literature, but the values was a lower than traditional SSC which allows due to the calcination temperature of anhydrate.

### Example 6: Mercury Intrusion Porometer

The porosity and pore size distribution of the SSC paste samples with and without the use of SF were determined using MIP. The total pores volume of SSC incorporating the SF was much less than that without the use of SF.

### Additional Embodiments

1. A composition comprising:
   a binder
   magnesium iron silicate; and
   a quartz powder.
2. The composition according to a preceding embodiment, wherein the binder comprises silica fume, magnesium oxide, and super-sulphated cement, or the binder comprises HS cement, or a combination thereof.
3. The composition according to a preceding embodiment, wherein the magnesium iron silicate is present in an amount, relative to the binder, from 0.8-1.8, from 1.0-1.2, from 1.4-1.8, from 1.6-1.8, from 0.8-1.0, from 0.8-1.2, from 0.8-1.4, from 0.8-1.6, from 1.0-1.2, from 1.1-1.3, from 1.2-1.4, or from 1.3-1.5.
4. The composition according to a preceding embodiment, wherein the magnesium iron silicate has a particle size distribution greater than 500 μm, greater than 600 μm, greater than 650 μm, greater than 700 μm, or greater than 750 μm.
5. The composition according to a preceding embodiment, wherein the magnesium iron silicate has a mean PSD at d₅₀ from 200-500 μm, from 250-500 μm, from 300-500 μm, from 350-500 μm, from 400-500 μm, from 200-300 μm, from 300-400 μm, from 250-350 μm, or from 350-450 μm.
6. The composition according to a preceding embodiment, wherein the magnesium iron silicate has a specific gravity from 2-3 g/cm³, 2.5-5 g/cm³, from 3.0-5 g/cm³, from 3.5-5 g/cm³, from 2.5-3.5 g/cm³, from 2.5-3.0 g/cm³, from 3.0-3.5 g/cm³, or from 3.0-4.0 g/cm³.
7. The composition according to a preceding embodiment, wherein the magnesium iron silicate comprises SiO₂ in an amount (relative to the magnesium iron silicate in total) that is from 30-50%, from 30-40%, from 35-50%, from 40-50%, from 45-50%, from 30-35%, from 35-45%, from 35-40%, or from 40-45%.
8. The composition according to a preceding embodiment, wherein the magnesium iron silicate comprises MgO in an amount (relative to the magnesium iron silicate in total) that is from 30-50%, from 30-40%, from 35-50%, from 40-50%, from 45-50%, from 30-35%, from 35-45%, from 35-40%, or from 40-45%.
9. The composition according to a preceding embodiment, wherein the magnesium iron silicate comprises FeO in an amount (relative to the magnesium iron silicate in total) that is from 5-20%, from 1-15%, from 5-10%, from 10-25%, from 10-20%, from 10-15%, from 15-20%, from 15-25%, or from 20-25%.
10. The composition according to a preceding embodiment, wherein the magnesium iron silicate comprises Fe₂O₃ in an amount (relative to the magnesium iron silicate in total) that is from 5-20%, from 5-15%, from 1-10%, from 10-25%, from 10-20%, from 10-15%, from 15-20%, from 15-25%, or from 20-25%.
11. The composition according to a preceding embodiment, wherein the magnesium iron silicate does not comprise TiO₂.
12. The composition according to a preceding embodiment, wherein the magnesium iron silicate comprises SiO₂ and Mg) in an amount (relative to the magnesium iron silicate in total) that is from 60-95%, from 70-95%, from 80-95%, from 85-95%, from 60-70%, from 65-75%, from 70-80%, from 75-85%, from 80-90%, or from 85-95%.
13. The composition according to a preceding embodiment, wherein the magnesium iron silicate comprises less than 0.25% Cr₂O₃.
14. The composition according to a preceding embodiment, wherein the magnesium iron silicate is derived from magnesium silicate rocks.
15. The composition according to a preceding embodiment, wherein the magnesium iron silicate is derived from magnesium silicate rock mine tailings.
16. The composition according to a preceding embodiment, wherein the magnesium iron silicate is derived from Twin Sisters dunite, Aheim's dunite or a combination thereof.
17. The composition according to a preceding embodiment, wherein the super sulphated cement comprises calcium sulfate, Portland cement, and slag.
18. The composition according to a preceding embodiment, wherein the super-sulphated cement comprises calcium sulphate in an amount from 5-25%, preferably 10-20%.
19. The composition according to a preceding embodiment, wherein the super-sulphated cement comprises Portland cement in an amount from 0.1-10%, preferably 1-5%,
20. The composition according to a preceding embodiment, wherein the super-sulphated cement comprises slag in an amount form 65-90%, preferably 75-85%.
21. The composition according to a preceding embodiment, wherein the super-sulphated cement comprises a slag comprising ground granulated blast-furnace slag.
22. The composition according to a preceding, wherein the binder comprises magnesium oxide in an amount (relative to the total binder) that is from 1-15%, from 1-10%, from 1-5%, from 2.5-7.5%, from 5-10%, or from 10-15%.
23. The composition according to a preceding embodiment, wherein the binder comprises silica fume in an amount (relative to the total binder) that is 15-45%, from 20-45%, from 25-45%, from 30-45%, from 35-45%, from 20-30%, from 25-35%, from 15-25%, or from 30-40%.
24. The composition according to a preceding embodiment, wherein the binder comprises super-sulfated cement in an amount (relative to the total binder) from 40-90%, from 50-90%, from 60-90%, from 70-90%, from 80-90%, from 40-60%, from 50-60%, from 45-65%, from 50-75%, from 55-65%, from 55-70%, from 55-70% from 55-80%, from 60-75%, from 60-70%, from 60-65%, or from 60-85%.
25. The composition according to a preceding embodiment, wherein the quartz powder has a size distribution of less than 100 μm, or less than 50 μm.
26. The composition according to a preceding embodiment, wherein the quartz powder has a mean PSD at d₅₀ of less than 100 μm, less than 75 μm, less than 50 μm, less than 40 μm, less than 30 μm, less than 20 μm, or less than 10 μm.
27. The composition according to a preceding embodiment, wherein the quartz powder is present in an amount, relative to the binder, that is from 0.1-0.5, from 0.2-0.5, from 0.3-0.5, from 0.4-0.5, from 0.1-0.2, from 0.15-0.25, from 0.2-0.3, from 0.25-0.35, from 0.3-0.4, 0.35-0.45, or from 0.4-0.5.
28. The composition according to a preceding embodiment, wherein the composition contains less that 1 wt. % of quartz having a particle size greater than 150 μm.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches

What is claimed is:

1. A composition comprising cement, silica fume, and an aggregate comprising magnesium iron silicate, wherein the magnesium iron silicate comprises course magnesium iron silicate, fine magnesium iron silicate, and optionally ultrafine magnesium iron silicate.

2. The composition of claim 1, wherein the cement comprises super sulfated cement comprising slag, anhydrite calcium sulfate, and Portland cement.

3. The composition of claim 1, wherein the composition comprises course magnesium iron silicate in an amount from 25-50 wt. % and fine magnesium iron silicate in an amount from 5-15 wt. %.

4. The composition of claim 1, wherein the course magnesium iron silicate has a particle size from about 140-1,000 μm, the fine magnesium silicate has a particle size from about 10-140 μm, and the ultrafine magnesium silicate has a particle size from about 0.01-10 μm.

5. The composition of claim 1, wherein the magnesium iron silicate comprises carbonated magnesium iron silicate, non-carbonated magnesium iron silicate, or a combination thereof.

6. The composition of claim 1, wherein the magnesium iron silicate is derived from magnesium silicate rock mine tailings.

7. The composition of claim 1, wherein the composition comprises cement in an amount from 25-45 wt. %.

8. The composition of claim 1, wherein the aggregate further comprises quartz sand, quartz powder, or a combination thereof.

9. The composition of claim 1, wherein the composition does not comprise quartz powder.

10. The composition of claim 1, wherein the composition does not comprise quartz sand.

11. A composition comprising super sulfated cement, silica fume, and an aggregate comprising magnesium iron silicate.

12. The composition of claim 11, wherein the cement comprises super sulfated cement comprising slag, anhydrite calcium sulfate, and Portland cement.

13. The composition of claim 11, wherein the magnesium iron silicate comprises course magnesium iron silicate, fine magnesium iron silicate, ultrafine magnesium iron silicate, or a combination thereof.

14. The composition of claim 11, wherein the magnesium iron silicate comprises course magnesium iron silicate and fine magnesium iron silicate.

15. The composition of claim 11, wherein magnesium iron silicate is present in an amount from 15-60 wt. %.

16. The composition of claim 11, wherein the composition comprises course magnesium iron silicate in an amount from 0-60 wt. %, fine magnesium iron silicate in an amount from 0-30 wt. %, and ultrafine magnesium iron silicate in an amount from 0-10 wt. %.

17. The composition of claim 16, wherein the course magnesium iron silicate has a particle size from about 140-1,000 μm, the fine magnesium silicate has a particle size from about 10-140 μm, and the ultrafine magnesium silicate has a particle size from about 0.01-10 μm.

18. The composition of claim 11, wherein the composition comprises silica fume in an amount from 5-20 wt. %

19. The composition of claim 11, wherein the magnesium iron silicate is derived from magnesium silicate rock mine tailings.

20. A method of making an article, comprising mixing the composition of claim 11 with water.
